(19) United States
(12) Patent Application Publication
(10) Pub. No.: US 2003/0008913 A1
(43) Pub. Date: Jan. 9, 2003

(54) Derivatives of 2,2-dimethyl 3(2-fluoro vinyl) cyclopropane carboxylic acid, their preparation process and their use as pesticides

(76) Inventors: Andrew Adams, Kriftel (DE); Jean Pierre Demoute, Kelkheim (DE); Jacques Demassey, Montevrain (FR); Didier Babin, Montigny (FR)

Correspondence Address: William F. Lawrence, Esq., FROMMER LAWRENCE & HAUG LLP, 745 Fifth Avenue, New York, NY, 10151, US

(21) Appl. No.: 10/140,787

(22) Filed: May 7, 2002

Related U.S. Application Data
(63) Continuation of application No. 09/581,977, filed on Aug. 25, 2000.

(30) Foreign Application Priority Data
Dec. 22, 1997 (FR) 9716243

(51) Int. Cl. A01N 65/00; A01N 43/08; A01N 53/00

(52) U.S. Cl. 514/461; 514/531; 560/124; 549/499; 514/65

(57) ABSTRACT

Compounds of formula (I) in which R represents the remainder of an alcohol used in the pyrethroid series, in all their possible stereoisomer forms as well as their mixtures, and compositions comprising them. The compounds of formula (I) are useful as pesticides.

Pyrethroids are lipophilic synthethic compounds orginally derived from the active principle of pyrethrum. They show insecticidal properties, based on on a strong influence on the sodium channels in the nerve membranes of the insects.

Several commercially used pyrethroids are of the general structure

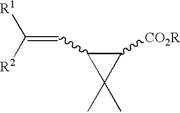

wherein R¹, R² can be halogen, CF₃ or CH₃ (see, e.g., EP-A 0 638 543, EP-A 0 498 724, EP-A 0 779 269 or EP-A 0 638 542).

In U.S. Pat. No. 4,176,189 hydanthoin methylols are disclosed as alcohol component of such pyrethroids.

The mentioned compounds show good activities as insecticides. There are however growing demands on pesticides with respect to, e.g., efficacy, dosage, range of controlled pests, toxicity, economy of production and resistance management. Therefore, it is an ongoing task to provide new pyrethroids which show at least partial improvement with respect to one or more of the mentioned items.

It has now surprisingly been found that pyrethroids of the formula (1) below are especially useful in combatting harmful pests.

Therefore, in one aspect of the invention there are provided compounds of formula (I):

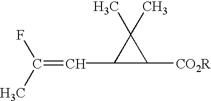

in all their possible stereoisomer forms as well as their mixtures in which R represents the remainder of an alcohol used in the pyrethroid series.

Preferably, R represents:

an alkyl radical c ontaining 1 and 18 atoms of carbon;

a benzyl radical optionally substituted by one or more radicals selected from the group consisting of alkyl radicals containing 1 to 4 carbon atoms, alkenyl radicals containing 2 to 6 carbon atoms, alkenyloxy radicals containing 2 to 6 carbon atoms, alkadienyl radicals containing 4 to 8 carbon atoms, the methylene dioxy radical and halogen atoms;

either a group:

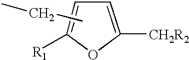

in which the substituent R₁Represents a hydrogen atom or a methyl radical and the substituent R₂ represents a monocyclic aryl or a —CH₂—C≡CH group; or a group:

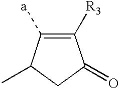

in which a represents a hydrogen atom or a methyl radical and R₃ represents the —CH₂—CH═CH₂, —CH₂—C═—CH, —CH₂—CH═CH—CH₃, —CH₂—CH═CH—CH═CH₂ or —CH₂—CH═CH—CH₂—CH₃ radical; or a group:

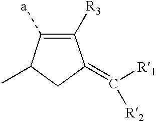

in which a represents a hydrogen atom or a methyl radical, R₃ retains the same meaning as previously, R′₁ and R′₂ identical or different, represent a hydrogen atom, a halogen atom, an alkyl radical containing 1 to 6 carbon atoms, an aryl radical containing 6 to 10 carbon atoms, an alkyloxycarbonyl group containing 2 to 5 carbon atoms, or a cyano group;

or a group:

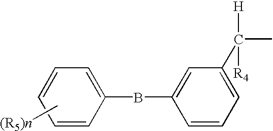

in which B represents an oxygen or sulphur atom, —C(O)— or —CH₂—, R₄ represents a hydrogen atom, a —C≡N radical, a methyl radical, a CONH₂ radical, a —CSNH₂ radical or a —C≡CH radical, R₅ represents a halogen atom or a methyl radical and n represents a number equal to 0,1 or 2;

or a group:

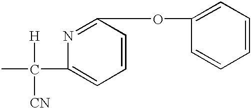

or a group:

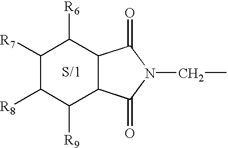

in which the substituents R₆, R₇, R₈ and R₉ represent a hydrogen atom, a chlorine atom, or a methyl radical and in which S/I symbolizes an aromatic cycle or an analogous dihydro or tetrahydro cycle;

or a group:

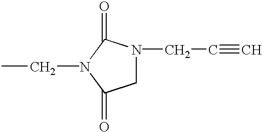

or a group:

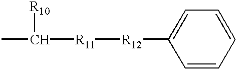

in which R₁₀ represents a hydrogen atom or a CH radical, preferably CH₃, R₁₂ represents a —CH₂— radical or an oxygen atom, R₁₁Represents a thiazyl radical or a thiadiazyl whose bond with:

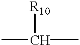

can be located at any one of the available positions, R₁₂ being linked to R₁₁ by the carbon atom between the sulphur atom and a nitrogen atom;

or a group:

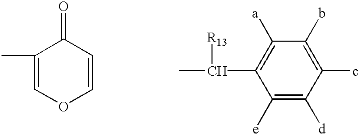

in which R₁₃ represents a hydrogen atom or a C—CH or CN radical, a, b, c, d, e represent a hydrogen atom, a halogen atom, an alkyl, O-alkyl or S-alkyl radical containing up to 8 carbon atoms, saturated or insaturated, optionally substituted by one or more halogen atoms, a CN, NO₂, NH₂ or OH radical, or R represents a radical:

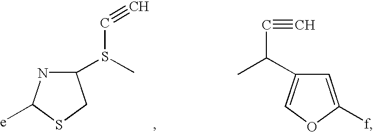

in which e and f represent a methyl, CH₂F, CHF₂or CF₃ radical;

or R represents an aryl group containing 6 to 14 carbon atoms, optionally substituted by one or more OH, O-alkyl or alkyl groups containing 1 to 8 carbon atoms or by a CF₃, OCF₃ or SCF₃ group;

or R represents a pyridinyl, furanyl, thiophenyl oxazolyl or thiazolyl radical.

Especially preferred are the compounds in which R represents a radical:

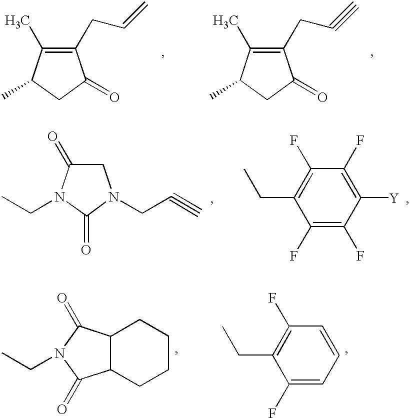

wherein Y represents a hydrogen or halogen atom, a hydroxyl, NO₂, CN or NH₂, CH₂OH or CH₂OCH₃ radical, an alkyl, O-alkyl or S-alkyl radical containing up to 8 carbon atoms, optionally substituted by one or more halogen atoms, and/or optionally interrupted by one or more, preferably one or two, heteroatoms, preferably from the group consisting of O, S and N.

Among these preferred compounds, there can be particularly mentioned the compounds in which R represents the radical:

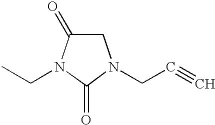

A more particular subject of the invention is the compounds the preparation of which is given below in the experimental part and in particular the products of Examples 14, 27 and 43.

The subject of the invention is also a preparation process characterized in that an acid of formula (11):

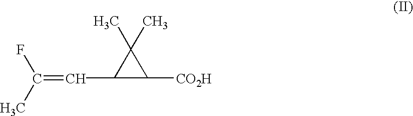

or a functional derivative of this acid in all possible stereoisomer forms as well as their mixtures is subjected to the action of an alcohol of formula (III):

ROH (III)

wherein R is preferably the remainder of an alcohol used in the pyrethroid series, or a functional derivative of this alcohol, and in this way, the sought compound of formula (I) is obtained.

The functional derivative of the acid is preferably an acid chloride. When an acid of formula (II) is reacted with the alcohol of formula (Ill), the operation is preferably carried out in the presence of diclohexylcarbodiimide.

The acids of formula (II) used as starting products of the process of the invention are new products and are themselves a subject of the present invention, their preparation is given below in the experimental part.

They are prepared from the products of formula (A):

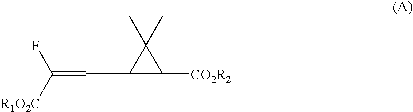

in which R₁ and R₂ represent a hydrogen atom or an alkyl radical containing up to 8 carbon atoms. The products of formula (A) are known products described in EP-A 0 050 354.

While being tolerated well by plants and having favorable toxicity toward warm-blooded animals, the compounds of formula (I) are suitable for controlling animal pests, especially insects, arachnids, helminths and molluscs, and very particularly preferably for controlling insects and arachnids, which are encountered in the hygiene sector, in animal breeding, in forestry, in the protection of stored products and materials, and in agriculture. They are active against normally sensitive and resistant species and against all or certain stages of development. The abovementioned pests include: From the order of the Acarina, for example, Acarus siro, Argas spp., Omithodoros spp., Dermanyssus gallinae, Eriophyes ribis, Phyllocoptruta oleivora, Boophilus spp., Rhipicephalus spp., Amblyomma spp., Hyalomma spp., ixodes spp., Psoroptes spp., Chorioptes spp., Sarcoptes spp., Tarsonemus spp., Bryobia praetiosa, Panonychus spp., Tetranychus spp., Eotetranychus spp., Oligonychus spp. and Eutetranychus spp.

From the order of the Isopoda, for example, Oniscus asselus, Armadium vulgar and Porcellio scaber.

From the order of the Diplopoda, for example, Blaniulus guttulatus.

From the order of the Chilopoda, for example, Geophilus carpophagus and Scutigera spp.

From the order of the Symphyla, for example, Scutigerella immaculata.

From the order of the Thysanura, for example, Lepisma saccharina.

From the order of the Collembola, for example, Onychiurus armatus.

From the order of the Orthoptera, for example, Blatta orientalis, Periplaneta americana, Leucophaea madeirae, Blattella germanica, Acheta domesticus, Gryllotalpa spp., Locusta migratoria migratorioides, Melanoplus differentialis and Schistocerca gregaria.

From the order of the Isoptera, for example, Reticulitermes spp.

From the order of the Anoplura, for example, Phylloera vastatrix, Pemphigus spp., Pediculus humanus corporis, Haematopinus spp. and Linognathus spp.

From the order of the Mallophaga, for example, Trichodectes spp. and Damalinea spp.

From the order of the Thysanoptera, for example, Hercinothrips femoralis, Thrips tabaci and Franklinielia spp.

From the order of the Heteroptera, for example, Eurygaster spp., Dysdercus intermedius, Piesma quadrata, Cimex lectularius, Rhodnius prolixus and Triatoma spp.

From the order of the Homoptera, for example, Aleurodes brassicae, Bemisia tabaci, Trialeurodes vaporariorum, Aphis spp., Brevicoryne brassicae, Cryptomyzus ribis, Doralis fabae, Doralis pomi, Eriosoma lanigerum, Hyalopterus arundinis, Macrosiphum avenae, Myzus spp., Phorodon humuli, Rhopalosiphum padi, Empoasca spp., Euscelus bilobatus, Nephotettix cincticeps, Lecanium corni, Saissetia oleae, Laodelphax striatellus, Nilaparvata lugens, AonidielIa aurantii, Aspidiotus hederae, Pseudococcus Spp. and Psylla spp.

From the order of the Lepidoptera, for example, Pectinophora gossypiella, Bupalus piniarius, Cheimatobia brumata, Lithocolletis blancardella, Hyponomeuta padella, Plutella maculipennis, Malacosoma neustria, Euproctis chrysorrhoea, Lymantria spp., Bucculatrix thurberiella, Phyllocnistis citrella, Agrotis spp., Euxoa spp., Feltia spp., Earias insulana, Heliothis spp., Laphygma exigua, Mamestra brassicae, Panolis flammea, Prodenia litura, Spodoptera spp., Trichoplusia ni, Carpocapsa pomonelia, Pieris spp., Chilo spp., Pyrausta nubilalis, Ephestia kuehniella, Gaileria mellonella, Cacoecia podana, Capua reticulana, Choristoneura fumiferana, Clysia ambiguelia, Homona magnanima, Tortrix viridana.

From the order of the Coleoptera, for example, Anobium punctatum, Rhizopertha dominica, Bruchidius obtectus, Acanthoscelides obtectus, Hylotrupes bajulus, Agelastica alni, Leptinotarsa decemlineata, Phaedon cochleariae, Diabrotica spp., Psylloides chrysocephala, Epilachna varivestis, Atomaria spp., Oryzaephilus surinamensis, Anthonomus spp., Sitophilus spp., Otiorrhynchus sulcatus, Cosmopolites sordidus, Ceuthorrhynchus assimilis, Hypera postica, Dermestes spp., Trogoderma, Anthrenus spp., Attagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha melolontha, Amphimallon solstitialis, Costelytra zealandica and Lissorhoptus spp.

From the order of the Hymenoptera, for example, Diprion spp., Hoplocampa spp., Lasius spp., Monomorium pharaonis and Vespa spp.

From the order of the Diptera, for example, Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hypobosca spp., Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae and Tipula paludosa.

From the order of the Siphonaptera, for example, Xenopsylla cheopsis and Ceratophyllus spp.

From the order of the Arachnida, for example, Scorpio maurus and Latrodectus mactans.

From the class of the helminths, for example, Haemonchus, Trichostrongulus, Ostertagia, Cooperia, Chabertia, Strongyloides, Oesophagostomum, Hyostrongulus, Ancylostoma, Ascaris and Heterakis and also Fasciola.

From the class of the Gastropoda, for example, Deroceras spp., Arion spp., Lymnaea spp., Galba spp., Succinea spp., Biomphalaria spp., Bulinus spp. and Oncomelania spp.

From the class of the Bivalva, for example, Dreissena spp.

The plant-parasitic nematodes which can be controlled in accordance with the invention include, for example, the root-parasitic soil nematodes such as those of the genera Meloidogyne (root knot eelworms, such as Meloidogyne incognita, Meloidogyne hapla and Meloidogyne javanica), Heterodera and Globodera (cyst-forming nematodes, such as Globodera rostochiensis, Globodera pallida, Heterodera trifolii) and of the genera Radopholus (such as Radopholus similis), Pratylenchus (such as Pratylenchus neglectus, Pratylenchus penetrans and Pratylenchus curvitatus), Tylenchulus (such as Tylenchulus semipenetrans), Tylenchorhynchus (such as Tylenchorhynchus dubius and Tylenchorhynchus claytoni), Rotylenchus (such as Rotylenchus robustus), Helicotylenchus (such as Helicotylenchus multicinctus), Belonoaimus (such as Belonoaimus longicaudatus), Longidorus (such as Longidorus elongatus), Trichodorus (such as Trichodorus primitivus), and Xiphinema (such as Xiphinema index).

The compounds according to the invention can also be used to control the nematode genera Ditylenchus (stem parasites, such as Ditylenchus dipsaci and Ditylenchus destructor), Aphelenchoides (leaf nematodes, such as Aphelenchoides ritzemabosi) and Anguina (leaf-gall nematodes, such as Anguina tritici).

The invention also relates to compositions, especially insecticidal and acaricidal compositions, which comprise the compounds of the formula (I) in addition to suitable formulation auxiliaries.

The compositions according to the invention comprise the active compounds of the formula (I) in general in a proportion of from 0.001% to 95% by weight.

They can be formulated in various ways depending on the biological and/or chemicophysical parameters which prevail. Preferred possible formulations are therefore:

wettable powders (WP), emulsifiable concentrates (EC), emulsions, sprayable emulsions, sprayable solutions, oil- or water-based dispersions (SC), suspoemulsions (SE), dusting agents (DP), seed-ressing products, granules in the form of microgranules, spray granules, coated granules and adsorption granules, water-dispersible granules (WG), ULV formulations, microcapsules, waxes or baits.

These individual types of formulation are known in principle and are described, for example, in:

Winnacker-Kuchler, “Chemische Technologie” [Chemical Technology], Volume 7, C. Hauser Verlag Munich, 4th ed. 1986; van Falkenberg, “Pesticides Formulations”, Marcel Dekker N.Y., 2nd ed. 1972-73; K. Martens, “Spray Drying Handbook”, 3rd ed. 1979, G. Goodwin Ltd. London.

The formulation auxiliaries required, such as inert materials, surfactants, solvents and other additives, are likewise known and are described, for example, in: Watkins, “Handbook of Insecticide Dust Diluents and Carriers”, 2nd ed., Darland Books, Caldwell N. J.; H. v. Olphen, “Introduction to Clay Colloid Chemistry”, 2nd ed., J. Wiley & Sons, N.Y.; Marsden, “Solvents Guide”, 2nd ed., lnterscience, N.Y. 1950; McCutcheon's, “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schonfeldt, “Grenzflächenaktive Äthylenoxidaddukte” [Surface-Active Ethylene Oxide Adducts], Wiss. Verlagsgesell., Stuttgart 1967; Winnacker-Kuchler, “Chemische Technologie”, Volume 7, C. Hauser Verlag Munich, 4th ed. 1986.

Based on these formulations, it is also possible to produce combinations with other pesticidally active compounds, fertilizers and/or growth regulators, for example in the form of a readymix or a tank mix. Wettable powders are preparations, uniformly dispersible in water, which contain, beside the active compound and in addition to a diluent or inert material, wetting agents, for example polyethoxylated alkylphenols, polyethoxylated fatty alcohols, alkyl- or alkylphenolsulfonates, and dispersing agents, for example sodium ligninsulfonate or sodium 2,2′-dinaphthylmethane6,6′-disulfonate.

Emulsifiable concentrates are prepared by dissolving the active compound in an organic solvent, for example butanol, cyclohexanone, dimethylformamide, xylene or higher-boiling aromatics or hydrocarbons, with addition of one or more emulsifiers. As emulsifiers, the following can be used, for example: calcium salts of alkylarylsulfonates, such as Ca dodecylbenzenesulfonate, or nonionic emulsifiers such as fatty acid polyglycol esters, alkylaryl polyglycol ethers, fatty alcohol polyglycol ethers, propylene oxide/ethylene oxide condensation products, alkyl polyethers, sorbitan fatty acid esters, polyoxyethylene sorbitan fatty acid esters or polyoxyethylene sorbitol esters.

Dusting agents are obtained by grinding the active compound with finely divided solid substances, for example talc, natural clays such as kaolin, bentonite, pyrophillite or diatomaceous earth. Granules can be prepared either by atomizing the active compound onto adsorptive, granulated inert material or by applying active compound concentrates onto the surface of carriers such as sand or kaolinites, or of granulated inert material, by means of adhesives, for example polyvinyl alcohol or sodium polyacrylate, or alternatively mineral oils. Suitable active compounds can also be granulated in the fashion conventional for the preparation of fertilizer granules, if desired as a mixture with fertilizers.

In wettable powders, the concentration of active compound is generally from approximately 10 to 90% by weight, the remainder to 100% by weight being composed of customary formulation components. In the case of emulsifiable concentrates, the concentration of active compound may generally be from approximately 5 to 80% by weight. Formulations in dust form generally comprise from 5 to 20% by weight of active compound, sprayable solutions from about 2 to 20% by weight. In the case of granules, the content of active compound depends partly on whether the active compound is in liquid or solid form and on which granulation auxiliaries, fillers, etc. are being used.

In addition, the above mentioned formulations of active compound comprise, if appropriate, the adhesives, wetting agents, dispersants, emulsifiers, penetrants, solvents, fillers or carriers which are customary in each case.

The concentrates, which are in the commercially customary form, are if appropriate diluted in the customary manner for their use, for example using water in the case of wettable powders, emulsifiable concentrates, dispersions and some microgranules. Dust and granule preparations, and also sprayable solutions, are normally not diluted any further with other inert substances before being used.

The application rate required varies with the external conditions, such as temperature and humidity among others. It can fluctuate within wide limits, for example between 0.0005 and 10.0 kg/ha or more of active compound, but is preferably between 0.001 and 5 kg/ha.

The active compounds according to the invention may be present in their commercially customary formulations, and in the application forms prepared from these formulations, as mixtures with other active compounds, such as insecticides, altractants, sterilants, acaricides, nematicides, fungicides, growth regulators or herbicides.

The pesticides include, for example, phosphoric esters, carbamates, carboxylates, formamidines, tin compounds, compounds prepared by microorganisms, inter alia. Preferred co-components for mixtures are

1. from the group of the phosphorus compounds acephate, azamethiphos, azinphosethyl, azinphosmethyl, bromophos, bromophosethyl, cadusafos (F-67825), chlorethoxyphos, chlorfenvinphos, chlormephos, chlorpyrifos, chlorpyrifos-methyl, demeton, demeton-S-methyl, demeton-S-methylsulphone, dialifos, diazinon, dichlorvos, dicrotophos, dimethoate, disulfoton, EPN, ethion, ethoprophos, etrimfos, famphur, fenamiphos, fenitriothion, fensulfothion, fenthion, fonofos, formothion, fosthiazate (ASC-66824), heptenophos, isozophos, isothioate, isoxathion, malathion, methacrifos, methamidophos, methidathion, salithion, mevinphos, monocrotophos, naled, omethoate, oxydemeton-methyl, parathion, parathion-methyl, phenthoate, phorate, phosalone, phosfolan, phosphocarb (BAS-301), phosmet, phosphamidon, phoxim, pirimiphos, primiphos-ethyl, pirimiphos-methyl, profenofos, propaphos, proetamphos, prothiofos, pyraclofos, pyridapenthion, quinalphos, suiprofos, temephos, terbufos, tebupirimfos, tetrachlorvinphos, thiometon, triazophos, trichlorphon, vamidothion;

2. from the group of the carbamates alanylcarb (OK-135), aldicarb, 2-sec-butylphenyl methylcarbamate (BPMC), carbaryl, carbofuran, carbosulfan, cloethocarb, benfuracarb, ethiofencarb, furathiocarb-HCN-801, isoprocarb, methomyl, 5-methyl-m-cumenylbutyryl (methyl)carbamate, oxamyl, pirimicarb, propoxur, thiodicarb, thiofanox, 1-methylthio(ethylideneamino) N-methyl-N-(morpholinothio)carbamate (UC 51717), triazamate;

3. from the group of the carboxylates acrinathrin, allethrin, alphametrin, beta-cypermethrin, 5-benzyl-3-furylmethyl (E)-(1R)-cis-2,2-dimethyl-3-(2-oxothiolan-3-ylidenemethyl)cyclopropanecarboxylate, beta-cyfluthrin, beta-cypermethrin, bioallethrin, bioallethrin((S)-cyclopentyl isomer), bioresmethrin, biphenate, (RS)-1-cyano-1-(6-phenoxy-2-pyridyl)methyl (1RS)-trans-3-(4-tert-butylphenyl)-2,2-dimethylcyclopropanecarboxylate (NCI 85193), cycloprothrin, cyfluthrin, cyhalothrin, cythithrin, cypennethrin, cyphenothrin, deltamethrin, empenthrin, esfenvalerate, fenfluthrin, fenpropathrin, fenvalerate, flucythrinate, flumethrin, fluvalinate (D-isomer), imiprothrin (S41311), lambda-cyhalothrin, permethrin, pheothrin ((R)-isomer), prallethrin, pyrethrine (natural products), resmethrin, tefluthrin, tetramethrin, theta-cypermethrin (TD-2344), tralomethrin, transfluthrin, zeta-cypermethrin (F-56701);

4. from the group of the amidines amitraz, chlordimeform;

5. from the group of the tin compounds cyhexatin, fenbutatin oxide;

6. others abamectin, ABG-9008, acetamipirid, Anagrapha falcitera, AKD-1022, AKD3059, ANS-118, Bacillus thuringiensis, Beauveria bassianea, bensultap, bifenazate (D-2341), binapacryl, BJL-932, bromopropylate, BTG-504, BTG-505, buprofezin, camphechlor, cartap, chlorobenzilate, chlorfenapyr, chlorfluazuron, 2-(4-chlorophenyl)-4,5-diphenylthiophene (UBI-T 930), chlorfentezine, chromafenozide, (ANS-118), CG-216, CG-217, CG-234, A-184699, (2-naphthylmethyl) cyclopropanecarboxylate (Ro12-0470), cyromazin, diacloden (thiamethoxam), diafenthiuron, ethyl N-(3,5-dichloro 4*(1,1,2,3,3,3-hexafluoro-1-propyloxy)phenyl)carbamoyl)-2-chloro-benzocarboximidate, DDT, dicofol, difluobenzuron, N-(2,3-dihydro-3-methyl-1,3-thiazol-2-ylidene)-2,4-ylidene)-2,4-xylidene, dinobuton, dinocap, diofenolan, DPX-062, emamcetin-benzoate (MK-244), endosulfan, ethiprole, (sulfethiprole), ethofenprox, etoxazole (YI-5301), fenazaquin, fenoxycarb, fipronil, flumite, (flufenzine, SZI-121), 2-fluoro-5-(4-(4-ethoxyphenyl)-4-methyl-1-pentyl)diphenyl ether (MTI 800), granulosis and nuclear polyhedrosis viruses, fenpyroximate, fenthiocarb, flubenzimine, flucycloxuron, flufenoxuron, flufenprox (ICI-A-5683), fluproxyfen, gamma-HCH, halofenozide (RH-0345), halofenprox (MTI-732), hexaflumuron (DE473), hexythiazox, HOI-9004, hydramethyinon (AC 217300), lufenuron, imidacloprid, indoxacarb (DPX-MP062), kanemite (AKD-2023), M-020, MIT-446, ivermectin, M-020, methoxyfenozide (Intrepid, RH-2485), milbemectin, NC-196, neemgard, nitenpyram (TI-304), 2-nitromethyl-4,5-dihydro-6-H-thiazine (DS 52618), 2-nitromethyl-3,4-dihydrothiazole (SD 35651), 2-nitromethylene-1,2-thiazinan-3-ylcarbamaidehyde (WL 108477), pyriproxyfen (S-71639), NC-1 96, NC-111, NNI-9768, novaluron (MCW-275), OK-9701, OK-9601, OK-9602, propargite, pymethrozine, pyridaben, pyrimidifen (SU-8801), RH-0345, RH-2485, RYI-210, S-1283, S-1833, SB7242, SI-8601, silafluofen, silamadine (CG-177), spinosad, SU-9118, tebufenozide, tebufenpyrad (MK-239), teflubenzuron, tefuranitozine (MIT446), tetradifon, tetrasul, thiadoprid, thiocyclam, TI-435, tolfenpyrad (OMI-88), triazamate (RH-7988), trifumuron, verbutin, vertalec (Mykotal), YI-5301.

The above mentioned components for combinations are known active compounds of which many are described in The Pesticide Manual (Editor: Clive Tomlin), 11th edition (1997), Crop Protection Publications/ISBN 1-90-901396-118 795. The content of active compound in the use forms prepared from the commercial formulations can vary within wide limits, and the concentration of active compound in the use forms can be from 0.0001 up to 95% by weight of active compound, preferably between 1 and 50% by weight. Application is effected in a conventional fashion, matched to the use forms.

The content of the active compound in the use forms prepared from the commercial formulations may be from 0.00000001 to 95% by weight of active compound, preferably between 0.00001 and 1% by weight.

The compounds of formula (I) have useful properties which allow their use preferred for combating parasites. It can, for example, be used for combating parasites of vegetation, parasites of premises and parasites in humans and animals.

Thus it is that the products of the invention can be used to combat parasitic insects, nematodes and acarien parasites of vegetation and animals.

A particular subject of the invention is the use of the compounds of formula (I) to combat parasites of vegetation, parasites of premises and parasites of warm-blooded animals.

The active compounds according to the invention of the formula (I) are thus suitable for controlling endo- and ectoparasites in the veterinary sector or in the sector of animal husbandry.

The active compounds according to the invention are in this case applied in a known fashion, such as by oral application in the form of, for example, tablets, capsules, potions or granules, by dermal application in the form of, for example, dipping, spraying, pouring-on and spotting-on and powdering, and also by parenteral application in the form of, for example, injection.

The novel compounds, according to the invention, of the formula (i) can accordingly also be employed particularly advantageously in livestock husbandry (for example cattle, sheep, pigs and poultry such as chickens, geese etc.). In a preferred embodiment of the invention, the novel compounds, if appropriate in suitable formulations (cf. above) and if appropriate with the drinking water or feed, are administered orally to the animals. Since excretion in the droppings occurs in an effective fashion, the development of insects in the animal droppings can be prevented very simply in this fashion. The dosages and formulations suitable in each case are particularly dependent on the type and stage of development of the productive animals and also on the degree of infestation, and can easily be determined and fixed by conventional methods. In the case of cattle, the novel compounds can be employed, for example, in dosages of 0.01 to 1 mg/kg of body weight.

In addition, the compounds according to the invention are also suitable for use in technical fields, for example as wood preservatives, as preservatives in paints, in cooling lubricants for metalworking, or as preservatives in drilling and cutting oils.

The products of formula (I) can also be used preferably to combat insects and other parasites of the soil, for example, coleoptera such as Diabrotica, click beetles, and cockchafer grubs, myriapoda such as ‘greenhouse’ centipedes and millipedes, and diptera such as gall midges and lepidoptera such as owlet moths.

They are preferably used in doses of between 10 g and 300 g of active ingredient per hectare.

The products of the invention present an excellent shock effect.

The products of formula (I) can also be preferably used to combat insects in premises, in particular to combat flies, mosquitoes and cockroaches, particularly Blatella germanica and Periplanta americana.

The products of formula (I) are also photostable and are less toxic for mammals.

The combination of these properties means that the products of formula (I) correspond perfectly to modem demands: they allow for combating parasites whilst preserving the environment.

The products of formula (I) can also be used to combat vegetable acarien and nematode parasites.

The compounds of formula (I) can also be used to combat acarien parasites of animals, to combat, for example, ticks and notably ticks of the Boophilus species, those of the Hyalomnia species, those of the Amblyomnia species and those of the Rhipicephalus species or to combat all sorts of mange and notably sarcoptic mange, psoroptic mange and chorioptic mange.

Therefore a subject of the invention is also a composition for combatting parasites of warm-blooded animals, parasites of premises and vegetation, comprising one or more, preferably 1 to 3, of the products of formula (1) defined below and in particular the products of formula (1) of Examples 14, 27 and 43.

The subject of the invention is particularly an insecticide composition comprising one or more of the products defined below as active ingredient.

These compositions are prepared according to the usual processes of the agrochemical industry or the veterinary industry or the industry for products intended for animal fodder.

In those compositions intended for agricultural use and for use in premises, the active ingredient or ingredients can optionally have added to them one or more other pesticide agents preferably from the group listed above. These compositions can be presented in the form of powders, granules, suspensions, emulsions, solutions, aerosol solutions, combustible strips, baits or other preparations usually employed for the use of this type of compound. In addition to the active ingredient, these compositions comprise, in general, a vehicle and/or a non-ionic surfactant, ensuring, moreover, a uniform dispersion of the constitutive substances of the mixture. The vehicle used can be a liquid, such as water, alcohol, hydrocarbons or other organic solvents, a mineral, animal or vegetable oil, a powder such as talc, clays, silicates, kieselguhr or a combustible solid.

The insecticide compositions according to invention comprise preferably 0.001% to 10% by weight of active ingredient.

According to an advantageous operating method, for use in premises, the compositions according to the invention are used in the form of fumigant compositions and in the form of a solvent-based or water-based aerosol.

The compositions according to the invention can then advantageously comprise, for the non-active part, a combustible insecticide coil, or also an incombustible fibrous substrate. In the latter case, the fumigant obtained after incorporation of the active ingredient is placed on a heating apparatus such as an electric heater.

In the case where an insecticide coil is used, the inert support can be, for example, composed of Pyrethrum marc, Tabu powder (or Machilus Thumbergii leaf powder), Pyrethrum stem powder, cedar leaf powder, sawdust (such as pine sawdust), starch and coconut shell powder.

The dose of active ingredient can then be, for example, 0.03 to 1% by weight. In the case where an incombustible fibrous support is used, the dose of active ingredient can then be, for example, 0.03 to 95% by weight.

The compositions according to the invention for use in premises can also be obtained by preparing a sprayable oil based on the active ingredient, this oil soaking a lamp wick and then being set alight.

The concentration of active ingredient incorporated in the oil is, preferably, 0.03 to 95% by weight.

Another subject of the invention coves acaricidal and nematicidal compositions comprising at least one of the products of formula (I) defined below as active ingredient.

The insecticide compositions according to the invention, as acaricide and nematicide compositions, can optionally have one or more other pesticide agents added to them. The acaricide and nematicide compositions can be presented in particular in the form of powder, granules, suspensions, emulsions, solutions.

For acaricide use, wettable powders are preferably used, for foliar spraying, comprising 1 to 80% of active ingredient by weight, or liquids for foliar spraying comprising 1 to 500 g/l of active ingredient are preferably used. Powders for foliar dusting containing 0.05% to 3% of active ingredient can also be used.

For nematicide use, liquids for soil treatment comprising 300 to 500 g/l of active ingredient are preferably used.

The acaricide and nematicide compounds according to the invention are used, preferably, at doses comprised between 1 and 100 g of active ingredient per hectare. To increase the biological activity of the products of the invention, they can be added to standard synergists used in such cases, such as 1-(2,5,8-trioxadodecyl) 2-propyl 4,5-methylenedioxy benzene (piperonyl butoxide) or N-(2-ethyl heptyl) bicyclo[2,2-1]5-heptene-2,3-dicarboximide, or piperonyl-bis-2-(2′-n-butoxyethoxy) ethylacetal (tropital).

The compounds of formula (I) have an excellent general tolerance, and therefore a subject of the invention is also the products of formula (1), in particular to combat illnesses caused by ticks and mange in humans and animals.

The products of the invention are in particular used to combat lice as a preventative or curative and to combat mange.

The products of the invention can be administered by external route, by spraying, by shampooing, by bathing or painting on.

The product of the invention for veterinary use can also be administered by painting the spine according to the “pour-on” method.

It can also be pointed out that the products of the invention can also be used as biocides or as growth regulators.

Also a subject of the invention is the combinations endowed with insecticide, acaricide or nematicide activity, characterized in that they comprise as active ingredient, on the one hand at least one of the compounds of the general formula (1) and on the other hand, at least one of the pyrethrinoid esters chosen from the group constituted by the esters of allethrone, of 3,4,5,6-tetrahydrophthal-imidomethyl alcohol, of 5-benzyl-3-furyl methyl alcohol, of 3-phenoxybenzyl alcohols and of alpha-cyano-3-phenoxybenzyl alcohol with chrysanthemic acids, by the esters of 5-benzyl-3-furyl methyl alcohol with 2,2-dimethyl-3-(2-oxo-3-tetrahydrothiophenyl-ideneethyl)-cyclopropane-carboxylic acid, by the esters of 3-phenoxybenzyl alcohol and of alpha-cyano-3-phenoxybenzyl alcohols with 2,2-dimethyl-3-(2,2-dichlorovinyl)-cyclopropanecarboxylic acids, by the esters of alpha-cyano 3-phenoxybenzyl alcohol with 2,2-dimethyl 3-(2,2-dibromovinyl) cyclopropane carboxylic acids, by the esters of 3-phenoxybenzyl alcohol with 2-parachlorophenyl-2 isopropyl acetic acids, by the esters of allethrolone, of 3,4,5,6-tetrahydrophthalimidomethyl alcohol, of 5-benzyl-3-furyl methyl alcohol, of 3-phenoxybenzyl alcohol and of alpha-cyano-3-phenoxybenzyl alcohol with 2,2-dimethyl-3-(1,2,2,2-tetrahaloethyl) cyclopropanecarboxylic acids, in which “halo” represents a fluorine, chlorine or bromine atom, it being understood that the compounds (I) can exist in all their possible stereoisomer forms as well as the acid and alcohol copulas of the above pyrethrinoid esters.

The compounds of the formula (I) can also be employed for controlling pests in crops of known or still to be developed plants which are modified by genetic engineering. The transgenic plants generally have particularly advantageous properties, for example by resistance toward certain crop protection agents, resistance toward plant diseases or causative organisms of plant diseases, such as certain insects or microorganisms, such as fungi, bacteria or viruses. Other particular properties concern, for example, the harvest with respect to amount, quality, storage stability, composition and specific ingredients. Thus, transgenic plants having increased starch content or a modified quality of the starch, or those having a different fatty acid composition of the harvested goods are known.

Preference is given to the use in transgenic crops of economically important useful plants and ornamental plants, for example in cereals, such as wheat, barley, rye, oats, millet, rice, maniok and maize or else in crops of sugar beet, cotton, soya, rapeseed, potato, tomato, pea and other vegetable species.

When used in transgenic crops, in particular with resistance against insects, effects are frequently observed, in addition to the effects which can be observed in other crops toward posts, which are specific for the application in the respective transgenic culture, for example a modified or specifically broadened spectrum of pests which can be controlled, or modified application rates which can be used for the application.

The invention therefore also provides the use of compounds of the formula (I) for controlling harmful organisms in transgenic crop plants.

Throughout this specification, unless the context requires otherwise, the word “comprise”, or variations such as “comprises” or “comprising”, will be understood to imply the inclusion of a stated item or group of items, but not he exclusion of any other item or group of items, including method steps.

The disclosures in French patent application No. 97 16 24 30 00, from which this application claims priority, and in the abstract accompanying this application are incorporated herein by reference.

### EXAMPLES OF FORMULATIONS

PREPARATION 1: [1R-cis(Z)] 2→2-dimethyl-3-(2-fluoro-1-propenyl) cyclopropane carboxylic acid chloride

Stage A: [IR-cis(Z)] 2,2-dimethyl-3-(2-fluoro-3-methoxy-3-oxo-1-propenyl) cyclopropane carboxylic acid

Two drops of bromine were added at 20° C. to a solution containing 250 cm³ of a solution of carbon tetrachloride and 15 g of [IR-cis(E)] 2,2-dimethyl-3-(2-fluoro-3-methoxy-3-oxo-1-propenyl) cyclopropane carboxylic acid. Irradiation was carried out using a 250 watt lamp. The reaction mixture was concentrated under reduced pressure at 40° C. and 15 g of the sought product (acid ester Z) was obtained.

Stage B: [IR-cis(Z)] 2,2-dimethyl-3-(2-fluoro-3-methoxy-3-oxo-1-propenyl) cyclopropane carboxylate of (1,1-dimethyl) ethyl

2 drops of DMF and then 11 cm³ of (COCl)₂ were added at 0° C. to a solution containing 15 g of the product of the preceding stage and 160 cm³ of methylene chloride. The mixture was agitated for 15 minutes at 0° C. then for 3 hours at 20° C. It was concentrated under reduced pressure at 40° C., then taken up in 100 cm³ of toluene and concentrated under reduced pressure at 40° C. A product was obtained that was dissolved in 160 cm³ of toluene, followed by cooling down under nitrogen to 0° C. 21 cm³ of terbutanol and then 9 cm³ of pyridine were added. The temperature was allowed to rise to ambient temperature and agitation was carried out for 18 hours at 20° C. The reaction medium was diluted with ethyl acetate and washed with water, with an aqueous solution of sodium acid carbonate, with a 0.5 N solution of hydrochloric acid and with water. After drying, filtering and concentrating 21.61 9 of sought product was obtained.

STAGE C: [1R-cis(Z)] 2,2-dimethyl-3-(2-fluoro-3-hydroxy-3-oxo-1-propenyl) cyclopropane carboxylate of (1 ,1-dimethyl) ethyl

90 cm³ of a normal soda solution was added at 20° C. to a solution containing 21.61 g of the product of the preceding stage and 200 cm³ of methanol. The reaction medium was agitated for 30 minutes. The methanol was eliminated under reduced pressure, followed by taking up in water, washing with isopropyl ether, acidifying with a 2N solution of hydrochloric acid and extracting with ethyl acetate. After drying, filtering and concentrating 18.75 g of sought product was obtained.

STAGE D: [IR-cis(Z)] 2,2-dimethyl-3-(2-fluoro-3-hydroxy-1-propenyl) cyclopropane carboxylate of (1,1-dimethyl) ethyl

11 cm³ of triethylamine then 7.6 cm³ of ethyl chloroformate were added at 0° C. to a solution containing 18.75 g of the product of the preceding stage and 170 cm³ of THF. The reaction medium was agitated for 2 hours at 0° C., filtered, the precipitate was rinsed with 20 cm³ of THF. The filtrate obtained was introduced at −70° C. into a solution containing 140 cm³ of THF and 35 cm³ of methanol, and 6.8 g of sodium borohydride. The reaction medium was agitated for one hour at −70° C. and the temperature was allowed to rise to −30° C. until the end of gas evolution. The temperature was returned to −60° C. followed by pouring into a 2N solution of hydrochloric acid. 600 cm³ of ethyl acetate was added followed by saturation with sodium chloride. The reaction medium was decanted and extracted with ethyl acetate, followed by washing, drying, filtering and concentrating at 40° C. under reduced pressure. The residue was chromatographied on silica eluting with a heptane-ethyl acetate mixture, followed by washing with water, with a saturated solution of sodium acid carbonate and with salt water. The product obtained was dried, filtered, concentrated, chromatographied on silica elutihg with a heptane-ethyl acetate mixture (7-3). In this way 12.38 g of sought product was obtained.

STAGE E: [1R-cis(Z)] 2,2-dimethyl-3-(3-bromo-2-fluoro-I-propenyl) cyclopropane carboxylate of (1,1-dimethyl) ethyl

12.38 g of the product obtained in the preceding stage was dissolved at 0° C. under nitrogen in 150 cm³ of methylene chloride. 23.55 g of carbon tetrabromide and then a solution of 16 g of triphenylphosphine and 20 cm³ of methylene chloride were added. The reaction medium was agitated for 1 hour at 0° C., filtered, rinsed in methylene chloride and concentrated. After taking up in isopropyl ether, 40 cm³ of ethyl acetate and then 20 cm³ of methylene chloride were added. The reaction medium was triturated, filtered, concentrated and chromatographed on silica eluting with a hexane ethyl acetate mixture (9-1). 15.55 g of product was obtained.

STAGE F: [1R-cis(Z)] 2,2-dimethyl-3-(2-fluoro-1-propenyl) cyclopropane carboxylate of (1,1-dimethyl) ethyl

1.7 g of sodium borohydride was added at about 20° C. to a solution containing 15.55 g of the product of the preceding stage and 150 cm³ of DMSO. The reaction mixture was agitated for 1 hour 30 minutes, poured into a mixture of water, ice and hydrochloric add. Extraction was carried out three times with isopropyl ether followed by washing, drying, filtering and concentration. The product obtained was chromatographed eluting with a heptane-isopropyl ether mixture (95-5) 4.85 g of sought product was obtained.

STAGE G: [IRcis(Z)] 2,2-dimethyl-3-(2-fluoro-1-propenyl) cyclopropane carboxylic acid 0.5 g of p-toluene sulfonic acid (PTSA) was added to a solution containing 5.78 g of the product of the preceding stage and 50 cm³ of toluene. The reaction medium was taken to 120° C. until the end of gas evolution. The reaction medium was returned to 20° C., diluted with isopropyl ether, washed with water, dried, filtered and concentrated. 4.40 g of sought product was obtained.

STAGE H: [IR-cis(Z)] 2,2-dimethyl-3-(2 fluoro-1-propenyl) cyclopropane carboxylic acid chloride

1 drop of DMF and 4.5 cm³ of (COCl)₂ were added at 0° C. to a solution containing 4.4 g of the product of the preceding stage and 50 cm³ of methylene chloride. The reaction medium was concentrated, taken up in toluene and concentrated to dryness. After taking up in 35 cm³ of toluene a solution was obtained which was used as it was in the following examples.

General operating method starting from a solution of acid chloride in toluene:

5 cm³ of acid chloride (3.6 mmoles) is added at 20° C. to toluene in a solution containing 4 mmoles of alcohol to be esterified and 8 cm³ of toluene. The reaction medium is cooled down to 0° C., 0.35 cm³ of pyridine is added and the whole is left to return to 20° C. Filtration is carried out and the filtrate is chromatographed eluting with a heptaneethyl acetate mixture. In this way the sought product is obtained.

By operating as above starting from the corresponding alcohols, the following products were obtained:

TLC eluent: heptane-ethyl acetate

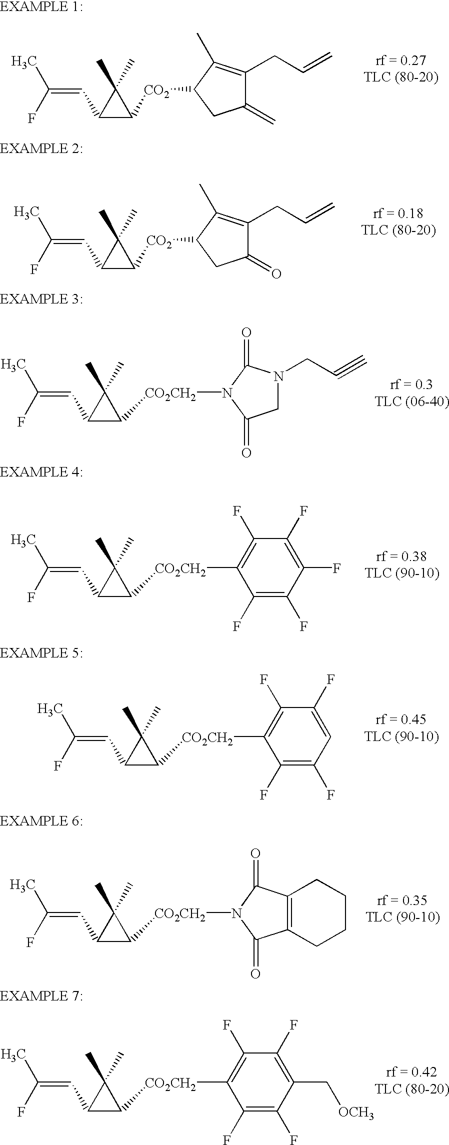

Preparation 2: [1R-trans(Z)] 2,2-dimethyl-3-(2-fluoro-1-propenyl) cyclopropane carboxylic acid chloride

STAGE A: [IR-trans(Z)] 2,2-dimethyl-3-(2-fluoro-3-methoxy-3-oxo-1-propenyl) cyclopropane carboxylate of (1 ,1-dimethyl) ethyl 15 g of [1R- trans(Z)] 2,2-dimethyl-3-(2-fluoro-3-methoxy-3-oxo-1-propenyl) cyclopropane carboxylic acid was dissolved in 150 cm³ of methylene chloride at 5° C. I drop of DMF and 10 cm³ of oxalyl chloride were added. The temperature was allowed to return to 20° C. The reaction medium was agitated for 3 hours under a nitrogen stream. Another drop of DMF and 2 cm³ of oxalyl chloride were added. The reaction medium was concentrated at 45° C. under reduced pressure, taken up in methylene chloride and brought to dryness. The residue obtained was taken up in 150 cm³ of methylene chloride and cooled down to 0° C. 20 cm³ of terbutanol was added. 12 cm³ of triethylamine was added. The temperature was allowed to rise to 20° C. and agitation was carried out under nitrogen pressure. 7 cm³ of pyridine was added, followed by agitation overnight at 20° C. The reaction medium was poured into a normal solution of hydrochloric acid to which ice was added. Extraction was carried out with methylene chloride followed by drying over magnesium sulphate. After filtering and concentrating 19.33 g of sought product was obtained.

STAGE B: [IR-trans(Z)] 2,2-dimethyl-3-(2-fluoro-3-hydroxy-3-oxo-1-propenyl) cyclopropane carboxylate of (1,1-dimethyl) ethyl

25 cm³ of a normal solution of soda was added to a solution containing 5.62 g of the product obtained in the preceding stage in 100 cm³ of methanol. The methanol was evaporated off under reduced pressure at 40° C. followed by dilution with 150 cm³ of solution containing water and 10 cm³ of a normal soda solution. Extraction was carried out with isopropyl ether. The aqueous phase was acidified with 20 cm³ of a 2N solution of hydrochloric acid. Extraction was carried out with methylene chloride followed by drying, filtering and concentrating. 5.25 g of product was obtained.

STAGE C: [IR-trans(Z)] 2,2-dimethyl-3-(2-fluoro-3-hydroxy-1-propenyl) cyclopropane carboxylate of (1 ,1-dimethyl) ethyl

54 g of the product of the preceding stage was dissolved in 1 l of THF at 0° C. 32 cm³ of TEA (triethyl amine) and then 22 cm³ of ethyl chloroformate were added. The reaction medium was agitated for 2 hours at 0° C., filtered, rinsed with THF and maintained overnight at 0° C. After cooling down to 70° C., 19.8 g of sodium borohydride and 100 cm³ of methanol were added. The temperature rose to −35° C. The reaction medium was agitated for 2 hours at −70° C. 100 cm³ of a 2N solution of hydrochloric acid was slowly poured in between −70° C. and 40° C. The reaction medium was poured into 2N hydrochloric acid. Sodium chloride was added until saturation, and extraction was carried out with ethyl acetate followed by drying, filtering and concentrating. Chromatography on silica was carried out, eluting with a heptane-ethyl acetate mixture (7-3) and in this way 27.58 g of sought product was obtained.

STAGE D: [1R-trans(Z)] 2,2-dimethyl-3-(3-bromo-2-fluoro-1-propenyl) cyclopropane carboxylate of (1,1-dimethyl) ethyl

26.59 of the product of the preceding stage was added at 2.5° C. to a solution containing 50 g of carbon tetrabromide and 250 cm³ of methylene chloride. 34 g of triphenyl phosphine in solution in 100 cm³ of methylene chloride was added over one hour. The reaction medium was concentrated at 40° C. under reduced pressure, taken up in 250 cm³ of isopropyl ether and maintained under agitation overnight at 20° C. After filtering, rinsing and concentrating 65.85 g of sought product was obtained.

STAGE E: [IR-trans (Z)] 2,2-dimethyl-3-(2-fluoro-1-propenyl) cyclopropane carboxylate of (1,1-dimethyl) ethyl

3.8 g of sodium borohydride was added at 20° C. to a solution containing 28 g of the product prepared previously and 300 cm³ of DM SO. The reaction medium was agitated for 1 hour 30 minutes, poured into a mixture of hydrochloric acid, water and ice. Extraction was carried out with isopropyl ether, followed by washing, drying, filtering and concentrating. 19.38 g of a product was obtained which was chromatographed on silica, eluting with a heptane-isopropyl ether mixture (95-5). 13.86 g of sought product was obtained.

STAGE F: [1R-trans(Z)] 2,2-dimethyl-3-(2-fluoro-1-propenyl) cyclopropane carboxylic acid

1.2 g of APTS was added to a solution containing 13.86 g of the product of the preceding stage and 140 cm³ of toluene.

The reaction medium was taken to 120° C., maintained under agitation for 30 minutes and the temperature returned to 20° C. Dilution was carried out with 250 cm³ of isopropyl ether followed by washing with water, drying, filtering and concentrating. 11 g of sought product was obtained.

STAGE G: [IR-trans(Z)] 2,2-dimethyl-3-(2-fluoro-1-propenyl) cyclopropane carboxylic acid chloride

3 drops of DMF and 10 cm³ of (COCl)₂ were added at 0° C. to a solution containing 10 g of the product of the preceding stage in solution in 100 cm³ of methylene chloride. The reaction medium was agitated for 45 minutes at 0° C. then for 2 hours 15 minutes at 20° C. Concentration was carried out at 40° C. followed by taking up in toluene and bringing to dryness. A product was obtained which was dissolved in 55 cm³ of toluene. In this way a 1 M solution of acid chloride in toluene was obtained.

Operating method 1:

50 mg of DMAP and 454 mg of DCC are added at 0° C. to a solution containing 379 mg of acid and 588 mg of the alcohol to be esterified and 20 cm³ of methylene chloride. The temperature is allowed to rise to 20° C. and agitation is carried out for 1 hour 30 minutes followed by filtering, diluting and washing with a 0.5N solution of hydrochloric acid. Decanting is carried out followed by drying, filtering, concentrating and taking up in toluene at 20° C. 0.5 g of tosyl alcohol is added followed by taking the reaction medium to 120° C. and returning it to 20° C. when the gas evolution is finished. Dilution is carried out with ethyl acetate followed by washing with sodium acid carbonate, drying, filtering and concencentrating. A product is obtained which is chromatographed on silica, eluting with a heptane-ethyl acetate mixture (80-20).

This operating method was particular to the alcohol

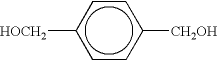

The operating method for the other esters was the same as for preparation A.

Operating Method 2:

The operation was carried out in the same way as Operating Method 1 used for Preparation 1.

In this way the following products were prepared:

TLC eluent—heptane-ethyl acetate (80-20)

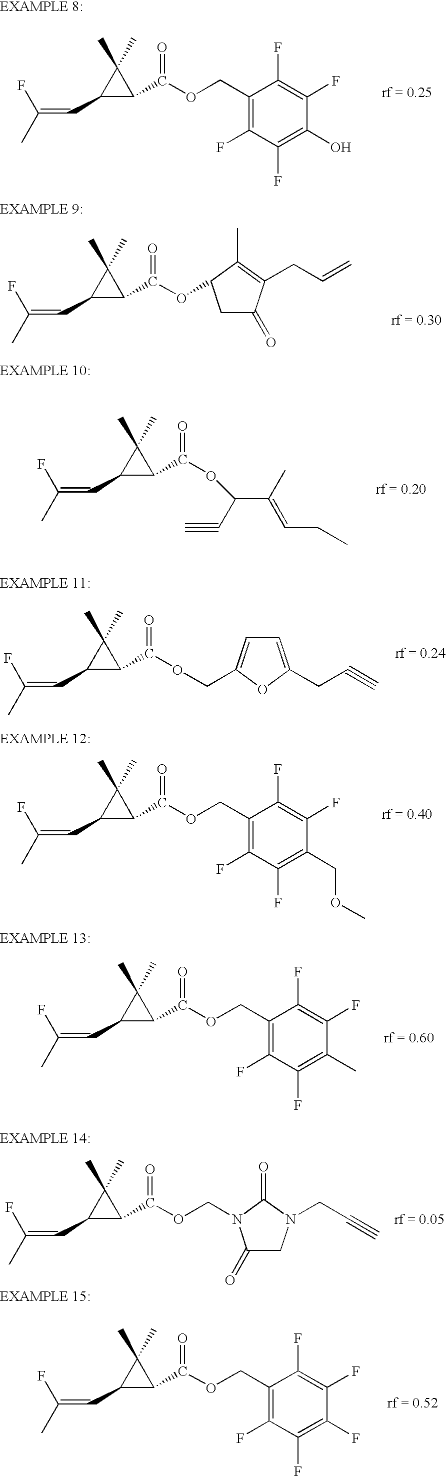

PREPARATION 3: [IR-cis(E)] 2,2-dimethyl-3-(2-fluoro-1-propenyl) cyclopropane carboxylic acid chloride

STAGE A: [1R cis(E)] 2,2-dimethyl-3-(2-fluoro-3-hydroxy-3-oxo-1-propenyl) cyclopropane carboxylate of (1,1-dimethyl) ethyl

A mixture of 56.87 g of [1R-cis(E)] 2,2-dimethyl-3-(2-fluoro-3-methoxy-3-oxo-1-propenyl) cyclopropane carboxylate of (1,1-dimethyl) ethyl, 260 cm³ of a normal solution of soda and 600 cm³ of methanol was maintained under agitation for 1 hour at 20° C. The reaction medium was acidifed, extracted with methylene chloride and with ethyl acetate. In this way 54.32 g of sought product was obtained.

STAGE B: [1R-cis(E)] 2,2-dimethyl-3-(2-fluoro-3-hydroxy-1-propenyl) cyclopropane of (1,1-dimethyl) ethyl

54.32 g of the product of Stage A were solubilized at 0° C. in 500 cm³ of tetrahydrofuran. 32 cm³ of triethylamine and 22 cm³ of ethyl chloroformate were added. The reaction medium was agitated for 2 hours at 0° C. followed by filtering, rinsing with THF, then maintained at 20° C. for 15 hours. A solution of 400 cm³ of THF and 100 cm³ of methanol was prepared which was cooled down to −70° C. This solution was added to the reaction mixture prepared previously and 19.8 g of sodium borohydride was also added over 30 minutes. The reaction mixture was agitated for 1 hour at −70° C. The temperature was allowed to rise to −30° C., producing a gas evolution. When this evolution slowed down, the temperature was returned to −70° C., followed by pouring into a 2N solution of hydrochloric acid. Ethyl acetate was added and the reaction medium was saturated with sodium chloride. Extraction was carried out with ethyl acetate followed by washing, drying, filtering and concentrating to dryness. After taking up in ethyl acetate, drying and filtering, concentration was carried out and 52 g of product was obtained which was chromatographed on silica eluting with a heptane-ethyl acetate mixture (7-3). In this way 38.26 g of sought product was obtained.

STAGE C: [1R-cis(E)] 2,2-dimethyl-3-(3-bromo-2-fluoro-1-propenyl) cyclopropane carboxylate of (1,1-dimethyl) ethyl

38.26 g of the product obtained in the previous stage was solubilized in 400 cm³ of methylene chloride. 72.7 g of carbon tetrabromide and then a solution of 49.3 g of triphenyl phosphine in 150 cm³ of methylene chloride were added followed by concentration at 40° C. at reduced pressure. 143 g of an oil was obtained to which 360 cm³ of isopropyl ether was added followed by bringing to dryness and taking up in ethyl acetate. After decanting and bringing to dryness 61.65 g of product was obtained which was chromatographed eluting with a heptane-ethyl acetate mixture (9-1). 49.58 9 of product was obtained.

STAGE D: [1R-cis(E)] 2,2-dimethyl-3-(2-fluoro-1-propenyl) cyclopropane carboxylate of (1,1-dimethyl) ethyl

28 g of the product prepared in the preceding stage was dissolved in 300 cm³ of DMSO at 20° C. 3.8 g of sodium hydroboride was added, while maintaining the temperature between 16° C. and 20° C. The reaction mixture was maintained under agitation for 1 hour followed by pouring into a mixture of water, ice and hydrochloric acid, washing with water, drying, filtering and concentrating. 18.94 g of product was obtained which was chromatographed on silica eluting with a heptane-isopropyl ether mixture (95-5), in this way the sought product was obtained (9.91 g). The impure product resulting from the first chromatography was chromatographed again eluting with a heptane-isopropyl mixture (95-5) and in this way 2.09 g of sought product was obtained. Thus a total of 12 g of sought product was obtained.

STAGE E: [1R-cis(E)] 2,2-dimethyl-3-(2-fluoro-1-propenyl) cyclopropane carboxylic acid

12 g of the product prepared in the preceding stage was dissolved at 20° C. in 120 cm³ of toluene. 1.3 g of PTSA was added. The reaction medium was taken to 120° C. until the end of gas evolution followed by diluting with 250 cm³ of isopropyl ether, washing with water, drying, filtering and concentrating at reduced pressure. 8.82 g of sought product was obtained.

STAGE F: [1R-cis(E)] 2,2-dimethyl-3-(2-fluoro-1-propenyl) cyclopropane carboxylic acid chloride

8.88 g of the product obtained in the preceding stage was dissolved at 0° C. in 100 cm³ of methylene chloride. 2 drops of DMF then 9 cm³ of (COCl)₂ were added over 1 minute. The reaction medium was agitated for 30 minutes at 0° C., the temperature was allowed to rise to 20° C. and agitation was carried out overnight. Concentration was carried out followed by taking up in toluene and returning the temperature to 40° C. After diluting with 52 cm³ of toluene a 1 M/l solution of acid chloride was obtained which was used as it was for preparation of the corresponding esters. By using the product of the preparation above the following products were prepared:

TLC eluent—heptane-ethyl acetate (80-20)

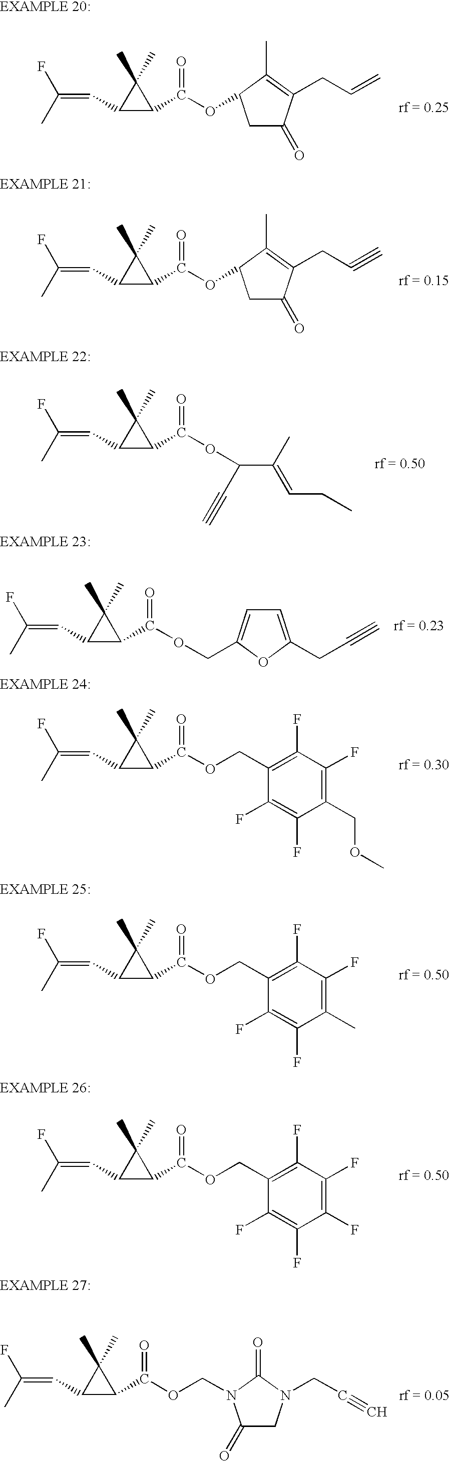

Preparation 4: [1R-trans(E)] 2,2-dimethyl-3-(2-fluoro-1-propenyl) cyclopropane carboxylic acid chloride

STAGE A: [1R-trans(E)] 2,2-dimethyl-3-(2-fluoro-3-hydroxy-1-propenyl) cyclopropane carboxylate of (1,1-dimethyl) ethyl

37.51 g of [1R-trans(E)] 2,2-dimethyl-3-(2-fluoro-3-hydroxy-3-oxo-1-propenyl) cyclopropane carboxylate of (1,1-dimethyl) ethyl was dissolved at 0° C. in 300 cm³ of THF. 22 cm³ of triethylamine, then 15 cm³ of ethyl chioroformate were added. The reaction medium was agitated for 1 hour 30 minutes at 0° C., filtered, rinsed with THF and separated. The solution obtained was added to a solution which was prepared as follows: a mixture of 250 cm of THF and 70 cm³ of methanol was cooled down to −70° C. and 12 g of sodium borohydride was added. Agitation was carried out for 1 hour at −70° C. The temperature was allowed to rise to −35° C., then returned to −50° C. and the reaction medium was poured into a 2N solution of HCl. Agitation was carried out for 10 minutes followed by saturation with sodium chloride, extraction with ethyl acetate, washing with sodium acid carbonate, drying, filtering and concentrating. The product obtained was chromatographed eluting with a heptane-ethyl acetate mixture (7-3). In this way 26.37 g of sought product was obtained.

STAGE B: [1R-trans (E)] 2,2-dimethyl-3-(3-bromo-2-fluoro-1-propenyl) cyclopropane carboxylate of (1 ,1-dimethyl) ethyl

26.37 g of the product obtained in the preceding stage was dissolved at 0° C. under a nitrogen atmosphere in 300 cm³ of methylene chloride. 40 g of carbon tetrabromide then 27 g of triphenyl phosphine dissolved in 40 cm³ of methylene chloride were added. The reaction medium was concentrated and isopropyl ether is added. The temperature was taken to 20° C. and filtration was carried out. The filtrate was concentrated and chromatographed on silica eluting with a heptaneethyl acetate mixture (9-1). In this way 35.12 g of sought product was obtained. STAGE C: [1R-trans(E)] 2,2-dimethyl-3-(2-fluoro-1-propenyl) cyclopropane carboxylate of (1,1-dimethyl) ethyl

33 g of the product of Stage B was dissolved at 18° C. in 330 cm³ of DMSO. 3 g of sodium borohydride was added. The reaction medium was agitated for 1 hour 15 minutes then poured into a mixture of water and ice. Extraction was carried out with isopropyl ether followed by washing, drying, filtering and concentrating. The product obtained was chromatographed eluting with a heptane-isopropyl ether mixture (95-5). 11.21 g of sought product was obtained.

STAGE D: [1R-trans(E)] 2,2-dimethyl-3-(2-fluoro-1-propenyl) cyclopropane carboxylate of (1,1-dimethyl) ethyl

1 g of PTSA was added at 20° C. to a solution containing 11.21 g of the product of the preceding stage and 100 cm¹ of toluene. The reaction medium was taken to 120° C. for 15 minutes, returned to 20° C., diluted with isopropyl ether, washed with water, dried, filtered and concentrated. 8.52 g of sought product was obtained.

STAGE E: [1R-trans(E)] 2,2-dimethyl-3-(2-fluoro-1-propenyl) cyclopropane carboylic acid chloride

1 drop of DMF and 9 cm³ of (COCl)₂ were added to a solution containing 8.52 g of the product of the preceding stage and 100 cm³ of methylene chloride. The reaction medium was agitated for 1 hour at 0° C. then for 16 hours at 20° C. The solvent was evaporated off followed by taking up in toluene and bringing to dryness. After taking up in 60 cm³ of toluene 60 cm³ of a toluenic solution of acid chloride was obtained at 0.8 mole per liter which was used as it was for the preparation of corresponding esters. The following esters were prepared:

TLC eluent—heptane-ethyl acetate (80-20)

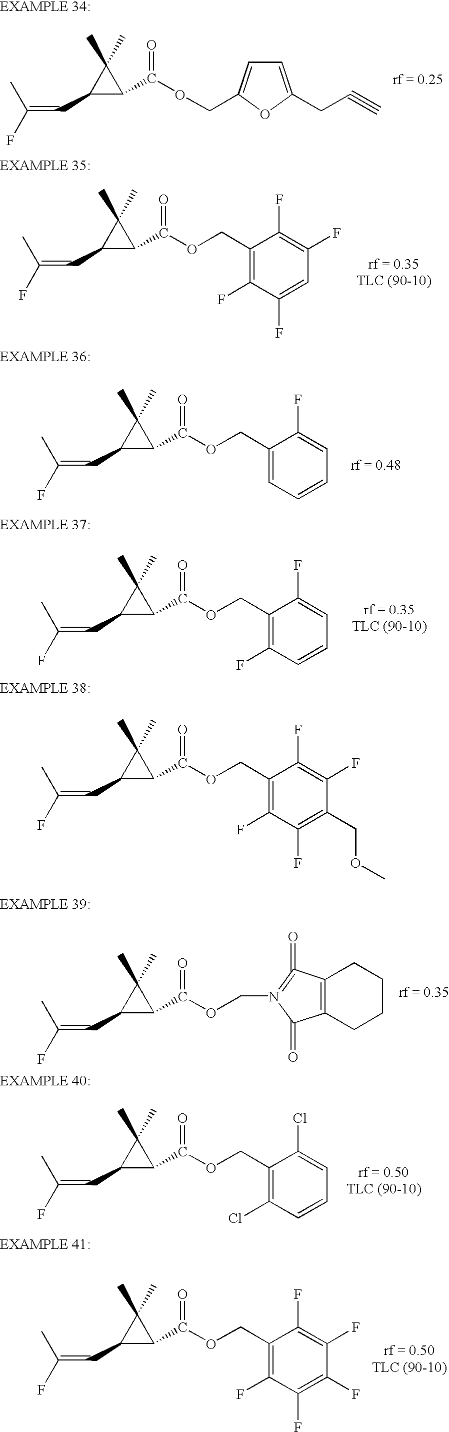

iological Activity:

1- Activity on Musca domestica

a) A fixed quantity of aerosol was sprayed in the centre of a room where the insects had previously been released.

b) The number of flies knocked down was determined at regular intervals. The KT₅₀, the time required for knocking down 50% of the insects originally present in the room, was calculated.

c) All of the flies, knocked down or alive, were collected and observed in a receptacle provided with food and water. The mortality was measured 24 hours after the treatment and expressed as a percentage of the initial population.

2—Action on Culex pipiens

The protocol used was the same as the protocol of the activity test for Musca domestics.

In the activity tests 1 and 2, the products showed a good action: a knock-down effect and a lethal effect.

3—Activity on Cockroaches

The action of the products was studied on Blatella germanica and Periplaneta americana using the standard so-called blowing tunnel test.

### EXAMPLE OF PESTICIDE COMPOSITIONS

Aerosols were prepared which had the following formulations. The quantities indicated were quantities by weight.

| EXAMPLE A: solvent base | |
|---|---|
| Product of Example 14 | 0.030 |
| Vegetable oil | 1.000 |
| Deodorized petroleum | 33.970 |
| Butane CAP 40 | 65.000 |
| | 100.000 |
| EXAMPLE B: solvent base | |
| Product of Example 43 | 0.025 |
| Solvent BVA XK₃ ® | 1.000 |
| Deodorized petroleum | 33.975 |
| Butane CAP 40 | 65.000 |
| | 100.000 |
| EXAMPLE C: aqueous base | |
| Product of Example 27 | 0.030 |
| Xylene | 4.000 |
| Span 80 ® | 0.500 |
| Shell sol T ® | 5.470 |
| Deionised water | 52.000 |
| Butane | 38.000 |
| | 100.000 |

### Comparative Example

The knockdown-effect at 30 seconds and 2 minutes of the compounds of Examples 14, 27, 43 and lmiprothrin, a commercially used pyrethroid, against Blattela was assessed.

The tests were carried out in a windtunnel. The active ingredient was diluted to 0.003% w/v in an 80% OPD 120 acetone mixture. Controls (i.e., sprayed with the carrier liquid alone) were inserted at the beginning of the test, and twice at the end.

Rate: 0.003%

| Compound | 30 sec.: | 2 min: |
|---|---|---|
| Ex. 14 | 30% | 70% |
| Ex. 27 | 70% | 90% |
| Imiprothrin | 0% | 10% |

Surprisingly, the compounds according to the invention are significantly more effective against Blattela than Imiprothrin.

1. Compounds of formula (I): 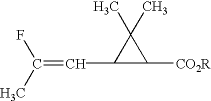
in all their possible stereoisomer forms as well as their mixtures in which R represents the remainder of an alcohol used in the pyrethroid series.

2. The compounds of formula (I) as defined in claim 1, wherein R represents:
an alkyl radical containing 1 and 18 atoms of carbon;
a benzyl radical optionally substituted by one or more radicals selected from the group consisting of alkyl radicals containing 1 to 4 carbon atoms, alkenyl radicals containing 2 to 6 carbon atoms, alkenyloxy radicals containing 2 to 6 carbon atoms, alkadienyl radicals containing 4 to 8 carbon atoms, the methylene dioxy radical and halogen atoms;
either a group: 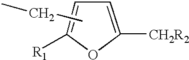
in which the substituent R₁Represents a hydrogen atom or a methyl radical and the substituent R₂ represents a monocyclic aryl or a —CH₂—C—CH group;
or a group: 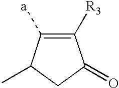
in which a represents a hydrogen atom or a methyl radical and R₃ represents the —CH₂—CH═CH₂, —CH₂—C═—CH, —CH₂—CH═CH—CH₃, —CH₂CH═CH—CH═CH₂ or —CH₂—CH═CH—CH₂—CH₃ radical; or a group: 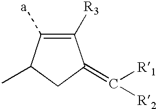
in which a represents a hydrogen atom or a methyl radical, R₃ retains the same meaning as previously, R′₁ and R′₂ identical or different, represent a hydrogen atom, a halogen atom, an alkyl radical containing 1 to 6 carbon atoms, an aryl radical containing 6 to 10 carbon atoms, an alkyloxycarbonyl group containing 2 to 5 carbon atoms, or a cyano group; or a group: 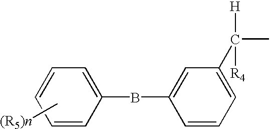
in which B represents an oxyygen or sulphur atom, —C(O)— or —CH₂—,
R₄ represents a hydrogen atom, a —C≡N radical, a methyl radical, a CONH₂ radical, a —CSNH₂ radical or a —C≡CH radical, R₅ represents a halogen atom or a methyl radical and n represents a number equal to 0,1 or 2;
or a group: 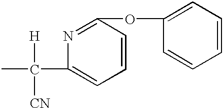
or a group: 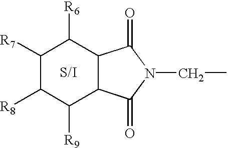
in which the substituents R₆, R₇, R₈ and R₉ represent a hydrogen atom, a chlorine atom, or a methyl radical and in which SI/I symbolizes an aromatic cycle or an analogous dihydro or tetrahydro cycle; or a group: 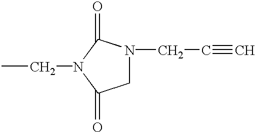
or a group: 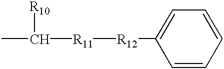
in which R₁₀ represents a hydrogen atom or a CH radical, R₁₂ represents a —CH₂— radical or an oxygen atom,
R₁₁Represents a thiazyl radical or a thiadiazyl whose bond with: 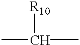
is located at any one of the available positions, R₁₂ being linked to R₁₁ by the carbon atom between the sulphur atom and a nitrogen atom; or a group: 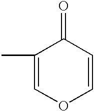
or a group: 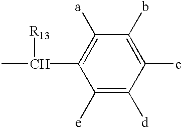
in which R₁₃ represents a hydrogen atom or a C═—CH or CN radical, a, b, c, d, e represent a hydrogen atom, a halogen atom, an alkyl, O-alkyl or S-alkyl radical containing up to 8 carbon atoms, saturated or insaturated, optionally substituted by one or more halogen atoms, a CN, NO₂, NH₂ or OH radical, or R represents a radical: 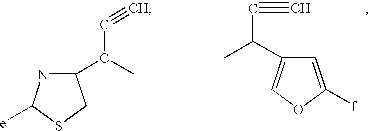
in which e and f represent a methyl, CH₂F, CHF₂ or CF₃ radical; or R represents an aryl group containing 6 to 14 carbon atoms, optionally substituted by one or more OH, O-alkyl or alkyl groups containing 1 to 8 carbon atoms or by a CF₃, OCF₃ or SCF₃ group; or R represents a pyridinyl, furanyl, thiophenyl oxazolyl or thiazolyl radical.

3. The compound of formula (I) defined in claim 1 or 2, in which R represents a radical: 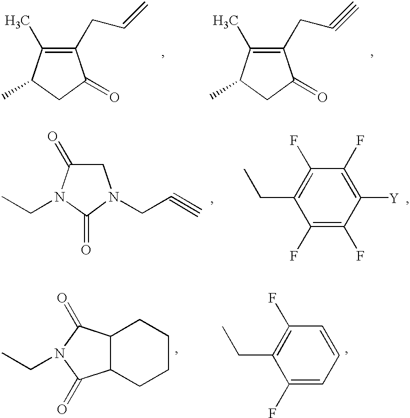
wherein Y represents a hydrogen or halogen atom, a hydroxyl, NO₂, CN or NH₂, CH₂O H or CH₂O CH₃ radical, an alkyl, O-alkyl or S-alkyl radical containing up to 8 carbon atoms, optionally substituted by one or more halogen atoms, and/or optionally interrupted by one or more heteroatoms.

4. The compounds of formula (I) defined in one or more of claims 1 to 3, in which R represents the radical:

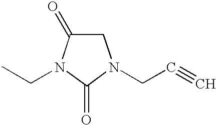

5. The compounds of formula (II) defined in one or more of claims 1 to 4, the names of which follow:
[R-trans(Z)] 2,2-dimethyl-3-(2-fluoro-i-propenyl) cyclopropane carboxylate of [2,5-dioxo-3-(2-propynyl)-1-imidazolidinyl] methyl
[IR-cis(E)] 2,2-dimethyl-3-(2-fluorol-propenyl) cyclopropane carboxylate of [2,5-dioxo-3-(2-propynyl)-1-imidazolidinyl] methyl
[IR-trans(E)] 2,2-dimethyl-3-(2-fluoro-i-propenyl) cyclopropane carboxylate of [2,5-dioxo-3-(2-propynyl)-1-imidazolidinyl] methyl.

6. A preparation process for the compounds of formula (I) defined in claim 1, characterized in that an acid of formula (II): 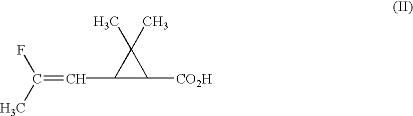
or a functional derivative of this acid in all possible stereoisomer forms as well as their mixtures is subjected to the action of an alcohol of the formula (III):
ROH (III)
wherein R is the reminder of an alcohol used in the pyrethroid series,
or a functional derivative of this alcohol, and in this way, the sought compound of formula (I) is obtained.

7. Compounds of formula (II) defined in claim 5.

8. Pesticide compositions comprising at least one compound defined in any one of claims 1 to 5 as an active ingredient.

9. The pesticide composition as claimed in claim 8, wherein the active ingredient is a compound as defined in claim 5.

10. A insecticidal, acaricidal or nematicidal composition as claimed in claim 8, comprising auxiliaries and additives which are customary for these applications.

11. A crop protection agent, comprising at least one compound of the formula (I) and at least one further active compound selected from the group of the fungicides, insecticides, acaricides, nematicides, herbicides, plant-growth regulators, sterilants and attractants together with the auxiliaries and additives which are customary for these applications.

12. A composition for protecting wood or as a preservative in sealing compounds, in paints, in cooling lubricants for metalworking or in drilling and cutting oils, which comprises an effective amount of at least one of the formula I as claimed in any of claims 1 to 5 together with auxiliaries and additives which are customary for this application.

13. Use of a compound of formula (I) as claimed in any of claims 1 to 5 in animal health for controlling endo- and ectoparasites.

14. A process for preparing a composition as claimed in claim 8, which comprises mixing one or more active compounds and other auxiliaries and additives and converting them into a suitable use form.

15. A method of controlling harmful insects, acarids and nematodes, which comprises applying an effective amount of a compound of the formula (I) as claimed in any of claims 1 to 5 or of a composition as claimed in claim 8 to these harmful insects, acarids and nematodes, or to the plants, areas or substrates infected with them.

16. Seed, treated or coated with an effective amount of a compound of the formula (I) as claimed in any of claims 1 to 5 or of a composition as claimed in claim 8.
